(19) United States
(12) Patent Application Publication
(10) Pub. No.: US 2009/0227216 A1
(43) Pub. Date: Sep. 10, 2009

(54) APPARATUS FOR UPDATING COEFFICIENT FOR DISTORTION COMPENSATION AND AMPLIFIER FOR COMPENSATING DISTORTION

(75) Inventor: Alexander N. Lozhkin, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/399,254

(22) Filed: Mar. 6, 2009

(30) Foreign Application Priority Data
Mar. 10, 2008 (JP) 2008-059032

(51) Int. Cl. H04B 1/04

(52) U.S. Cl. 455/114.3

(57) ABSTRACT

An apparatus for updating a coefficient for distortion compensation includes a compensation coefficient storing unit configured to store a plurality of distortion compensation coefficients used for a pre-distortion-compensation processing; a correction value generator configured to generate one or more correction values for one or more distortion compensation coefficients, based on a correction value which is calculated using a transmission signal before distortion compensation processing and an amplified signal after the distortion compensation processing to which a distortion compensation coefficient is applied, other than the applied distortion compensation coefficient; and an adder configured to add the correction value to the applied distortion compensation coefficient and add the one or more correction values to the one or more distortion compensation coefficients to update the plurality of distortion compensation coefficients.

### CROSS-REFERENCE TO RELATED APPLICATIONS

This application is based upon and claims the benefit of priority of the prior Japanese Patent Application No. 2008-59032, filed on Mar. 10, 2008, the entire contents of which are incorporated herein by reference.

### FIELD

Certain aspects of the present invention discussed herein are related to an apparatus for updating a coefficient for distortion compensation used for pre-distortion of signals to be amplified and an amplifier for compensating distortion.

### BACKGROUND

FIG. 6 illustrates an example of an amplifier compensating distortion to implement a digital pre-distorter (DPD). This distortion-compensating amplifier includes multiplying units 11, 21, a digital/analog converter (DAC) 12, a radio frequency (RF) I-Q modulator 13, a high power amplifier (HPA) 14, an address calculator 15, a reference table (LUT) 16, delay units 17 and 18, an adding unit 19, an updating unit 20, a subtracter 22, an analog/digital converter (ADC) 23 and an RF I-Q demodulator 24.

A complex sample S(t) of an input signal includes a real part I and an imaginary part Q, the multiplying unit 11 multiplies the sample S(t) by a coefficient for distortion compensation (hereinafter referred to as “distortion compensation coefficient”) h output from LUT 16, and DAC 12 converts the multiplication result to an analog signal and outputs the analog signal to the RF I-Q modulator 13. At this time, the address calculator 15 calculates a read address (ReadAddr) from the amplitude or power of the sample S(t), and outputs the calculation result to LUT 16 and the delay unit 18. The distortion compensation coefficient h is also a complex number, and LUT 16 stores the real part I and the imaginary part Q of the distortion compensation coefficient h for each address.

The RF I-Q modulator 13 up-converts the analog signal from DAC 12, HPA 14 amplifies the obtained conversion result and outputs it to an antenna (illustration is omitted) and also to the RF I-Q demodulator 24. The RF I-Q demodulator 24 down-converts the output signal of HPA 14, and ADC 23 converts the obtained conversion result to a digital signal y(t) and outputs it to the subtracter 22.

The delay unit 17 delays the sample S(t) by only a time A, and outputs the delayed sample S(t−Δ) to the subtracter 22. Accordingly, the transmission delay A is compensated until the sample S(t) is fed back from the multiplying unit 11 through HPA 14 to the subtracter 22, and the input sample can be compared with the correct output signal. The subtracter 22 calculates the difference in phase and amplitude between the delayed sample S(t−Δ) and the feedback signal y(t) corresponding to output signal of HPA 14, and outputs the calculated difference as an error signal ε=S(t−Δ)−y(t) to the multiplying unit 21.

The multiplying unit 21 multiplies the error signal ε by a coefficient μ, and outputs the multiplication result to the updating unit 20. The updating unit 20 estimates a correction value Ah for the distortion compensation coefficient on the basis of the output signal from the multiplying unit 21 according to a least mean square algorithm. The adding unit 19 adds the distortion compensation coefficient h stored in LUT 16 with the correction value Δh to calculate updated value h=h+Δh, and provides the updated value h′ to LUT 16. At this time, the delay unit 18 outputs as a write address (WriteAddr) a read address (ReadAddr) delayed by the time A to LUT 16.

As described above, the distortion compensation coefficient h is rewritten to the updated value h′, and the input sample S(t) is multiplied by the updated value h′, thereby compensating non-linear distortion in the output signal of HPA 14.

Japanese Laid-Open Patent Publication No. 2000-278190 relates to a distortion compensation coefficient updating method for updating a plurality of adjacent distortion compensation tables simultaneously just after a distortion compensating operation is started, and then stepwise reducing the number of distortion compensation tables which are simultaneously updated.

However, the method of updating the distortion compensation coefficient in the DPD described above has the following problem.

Normally, the distortion-compensating amplifier illustrated in FIG. 6 operates without suffering any band restriction, and all the constituent elements of the distortion-compensating amplifier have broad band widths. For example, In a transmitter of an OFDM (Orthogonal Frequency Division Multiplexing) communication system, DPD having a band width exceeding 50 MHz may be implemented for an OFDM signal having a band width of 5 MHz. In this case, only out-of-band spectral components of a spectral region which is far from the signal are suppressed by the DPD band width.

However, when the DPD band width approaches the band width of the input signal S(t), the situation turns over. For example, this is such a case when the band width of the input signal S(t) is equal to 5 MHz and the DPD band width is equal to 20 MHz.

During the operation of the distortion-compensating amplifier, the multiplication between the input sample S(t) and the distortion compensation coefficient h damages the waveform of the output signal of the multiplying unit 11. Such distortion of the signal waveform in the time area induces expansion of the corresponding signal spectrum in the frequency area. The mechanism of the expansion of the signal spectrum is similar to that used in a spread spectrum communication system such as W-CDMA (Wideband Code Division Multiple Access) or UMT (Universal Mobile Telecommunications)—2000 or the like. As described above, the signal S(t)*h after the distortion compensation has a broad band width.

Here, if the overall DPD band width is broader than the band width of the signal S(t)*h, the distortion-compensating amplifier operates properly, and the non-linearity of HPA 14 may be improved. If not so, the distortion-compensating amplifier does not operate properly, and thus the non-linearity of HPA 14 may not be improved.

Furthermore, when a frequency selecting circuit, such as a low pass filter (LPF), a band pass filter (BPF) or the like, is mounted to enhance the signal-to-noise ratio (SNR), the DPD bandwidth decreases greatly. Such a filter is normally mounted as a part of the RF I-Q modulator 13 and the RF I-Q demodulator 24, or as an additive frequency selecting circuit for performing base band filtering of the output signal of the multiplying unit 11.

When a LPF or BPF is mounted, SNR may be enhanced, and undesired spectral components may be removed from the RF I-Q modulator 13 and the RF I-Q demodulator 24. Accordingly, the updating precision of the distortion compensation coefficient h may be enhanced.

FIG. 7 illustrates an example of the construction of the distortion compensating amplifier in which LPF is mounted as an additive frequency selecting circuit. This distortion compensating amplifier includes the construction that LPFs 31 and 32 are added to the distortion compensating amplifier illustrated in FIG. 6. The operations of the constituent elements having the same reference numerals as the constituent elements illustrated in FIG. 6 are the same as illustrated in FIG. 6. LPF 31 filters the output signal of DAC 12 and outputs the filtering result to the RF I-Q modulator 13, and LPF 32 filters the output signal of the FRI-Q demodulator 24 and outputs the filtering result to ADC 23.

In the construction of a narrow band DPD as described above, the DPD band width is narrowed due to the mount of LPF, and it approaches the band width of the signal S(t)*h after the distortion compensation. Therefore, the linearity performance of the normal distortion compensation processing is lowered, and the out-of-band power may not be sufficiently reduced.

### SUMMARY

Accordingly, in a certain aspect, an object of the invention is to suppress reduction of distortion compensation processing performance.

According to one aspect of the invention, an apparatus for updating a coefficient for distortion compensation includes a compensation coefficient storing unit configured to store a plurality of distortion compensation coefficients used for a pre-distortion-compensation processing; a correction value generator configured to generate one or more correction values for one or more distortion compensation coefficients, based on a correction value which is calculated using a transmission signal before distortion compensation processing and an amplified signal after the distortion compensation processing to which a distortion compensation coefficient is applied, other than the applied distortion compensation coefficient; and an adder configured to add the correction value to the applied distortion compensation coefficient and add the one or more correction values to the one or more distortion compensation coefficients to update the plurality of distortion compensation coefficients.

According to one aspect of the invention, a method of updating a coefficient for distortion compensation includes generating one or more correction values for one or more distortion compensation coefficients, based on a correction value which is calculated using a transmission signal before distortion compensation processing and an amplified signal after the distortion compensation processing to which a distortion compensation coefficient is applied, other than the applied distortion compensation coefficient; and updating the applied distortion compensation coefficient based on the correction value and updating the one or more distortion compensation coefficients based on the one or more correction values.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a distortion compensating amplifier according to an embodiment;

FIG. 2 illustrates an example of an adding unit and a multiplying unit;

FIG. 3 illustrates a weighting coefficient;

FIG. 4 illustrates a power spectrum of OFDM signals;

FIG. 5 illustrates an example of a construction of a base station device;

FIG. 6 illustrates an example of a conventional distortion compensation amplifier; and

FIG. 7 illustrates an example of a distortion compensating amplifier including LPFs.

### DESCRIPTION OF EMBODIMENTS

Embodiments for carrying out the present invention are described with reference to the drawings.

According to a first aspect, an apparatus for updating a coefficient for distortion compensation includes a compensation coefficient storing unit, a correction value generator and an adding unit.

The compensation coefficient storing unit stores a plurality of distortion compensation coefficients used for a pre-distortion-compensation processing. On the basis of a correction value which is calculated based on a transmission signal before distortion compensation processing and an amplified signal after the distortion compensation processing based on a distortion compensation coefficient (h) out of the plurality of distortion compensation coefficients, the correction value generator generates one or more correction values for one or more distortion compensation coefficients other than the distortion compensation coefficient (h).

The adding unit adds the distortion compensation coefficient (h) with the correction value calculated based on the transmission signal and the amplified signal, adds the one or more correction values to the one or more distortion compensation coefficients respectively, and updates the distortion compensation coefficient of the compensation coefficient storing unit based on the obtained addition result.

According to the construction described above, a plurality of distortion compensation coefficients are simultaneously updated based on the correction value, and thus the correlation of the respective distortion compensation coefficients is strengthened. Accordingly, the correlation between the signals after the distortion compensation processing based on the distortion compensation coefficient is strengthened, and thus the signal band width after the distortion compensation is reduced. Accordingly, it may be possible to maintain the signal band width after the distortion compensation to be narrower than the DPD band width, and the performance deterioration of the distortion compensation processing may be prevented.

According to a second aspect of an embodiment, the distortion compensating amplifier includes a compensation coefficient storing unit, an updating unit, a correction value generator, an adding unit, a multiplying unit and an amplifier.

The compensation coefficient storing unit stores a plurality of distortion compensation coefficients used in pre-distortion-compensation processing. The updating unit calculates a correction value based on a transmission signal before distortion compensation processing and an amplified signal after the distortion compensation processing based on a distortion compensation coefficient (h) out of the plurality of distortion compensation coefficients. The correction value generator generates one or more correction values for one or more distortion compensation coefficients other than the distortion compensation coefficient (h) described above.

The adding unit adds the distortion compensation coefficient (h) with the correction value calculated based on the transmission signal and the amplified signal, adds the one or more correction values to the one or more distortion compensation coefficients respectively, and updates the distortion compensation coefficients of the compensation coefficient storing unit based on the obtained addition result. The multiplying unit multiplies the transmission signal before the distortion compensation processing by the updated value of the distortion compensation coefficient (h). The amplifier amplifies the signal obtained through the multiplication of the multiplying unit, and outputs the amplified signal.

According to the construction as described above, the signal band width after the distortion compensation may be maintained narrower than the DPD band width as in the case of the apparatus for updating the distortion compensation coefficient, and the performance deterioration of the distortion compensation processing is prevented.

An embodiment is described in detail with reference to the drawings.

The level of a side lobe in a power spectrum is lowered, and thus the signal band width is narrower, as the correlation between signal samples is stronger. Particularly, in the case of an over-sampled signal, there is strong correlation between samples, and thus the signal band width is narrowed. Accordingly, in order to suppress the spreading of the band width of the signal S(t)*h after the distortion compensation, the correlation between signals after the distortion compensation may be strengthened. Therefore, it would be effective to adopt the updating processing of strengthening the correlation between the distortion compensation coefficients.

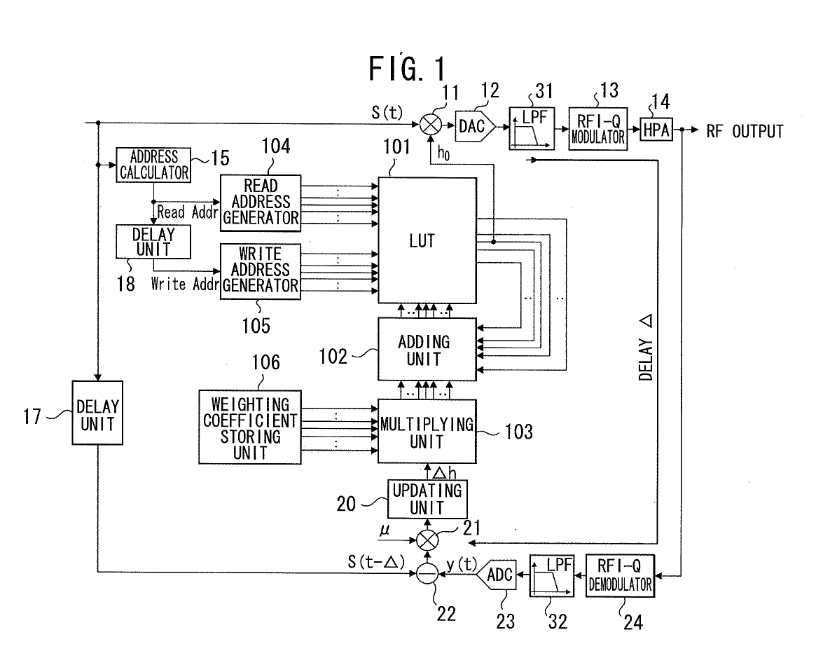

FIG. 1 illustrates an example of a distortion compensation amplifier of an embodiment which adopts such an updating processing.

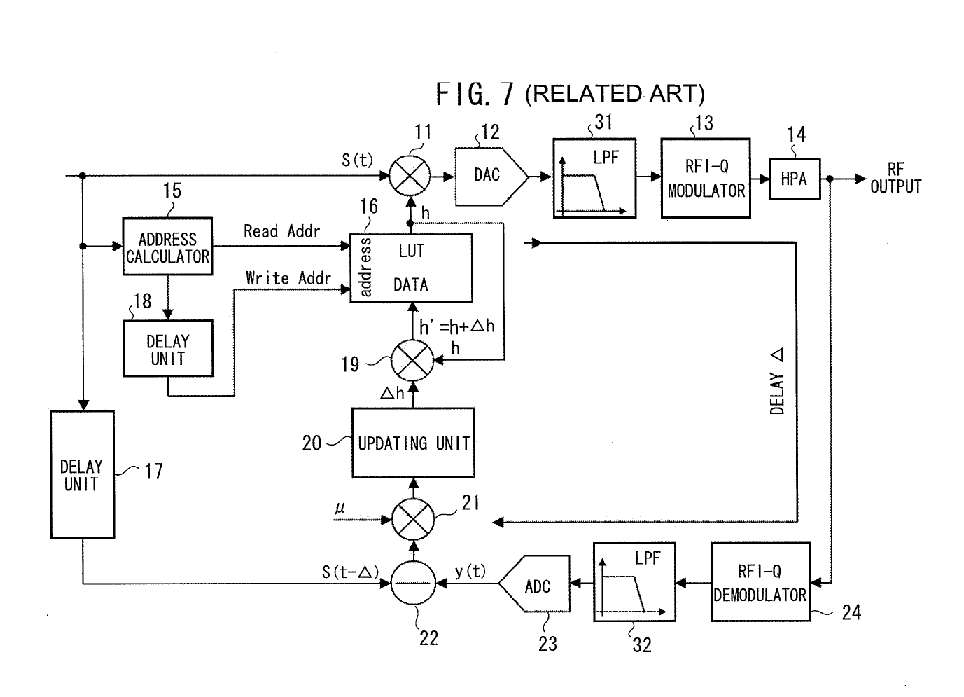

The distortion compensation amplifier has the construction that the LUT 16 and the adding unit 19 are replaced by LUT 101 and an adding unit 102, and a multiplying unit 103, a read address generator 104, a write address generator 105 and a weighting coefficient storing unit 106 are added to the distortion compensating amplifier illustrated in FIG. 7. The operation of elements having the same reference numerals as those of FIG. 7 is the same as illustrated in FIG. 7. In this distortion compensating amplifier, not one entry of LUT 101, but a plurality of adjacent entries are simultaneously updated in parallel.

On the basis of a read address (ReadAddr) of a distortion compensation coefficient h0 output from the address calculator 15, the read address generator 104 generates addresses of (N+1) in total, including addresses of N which are located before and after the read address, and outputs the generated addresses to LUT 101. On the basis of a write address (writeAddr) output from a delay unit 18, the write address generator 105 generates addresses of (N+1), in total, including addresses of N which are located before and after the write address, and outputs the generated addresses to LUT101.

Accordingly, both the read address generator 104 and the write address generator 105 generate the address of the distortion compensation coefficient h₀ in LUT 101 and the addresses of N which are adjacent to the address of the distortion compensation coefficient h₀. Here, N represents an even number.

The weighting coefficient storing unit 106 stores the weighting coefficients of (N+1) corresponding to the distortion compensation coefficients stored in the addresses of (N+1), and outputs them to the multiplying unit 103. The multiplying unit 103 multiplies the correction value Δh output from the updating unit 20 by each of the weighting coefficients of (N+1), and outputs the multiplication results of (N+1) to the adding unit 102. The adding unit 102 adds each of the multiplication results to each of the distortion compensation coefficients of (N+1) output from LUT 101, and outputs the addition results of (N+1) as updated values of the respective distortion compensation coefficients to LUT 101.

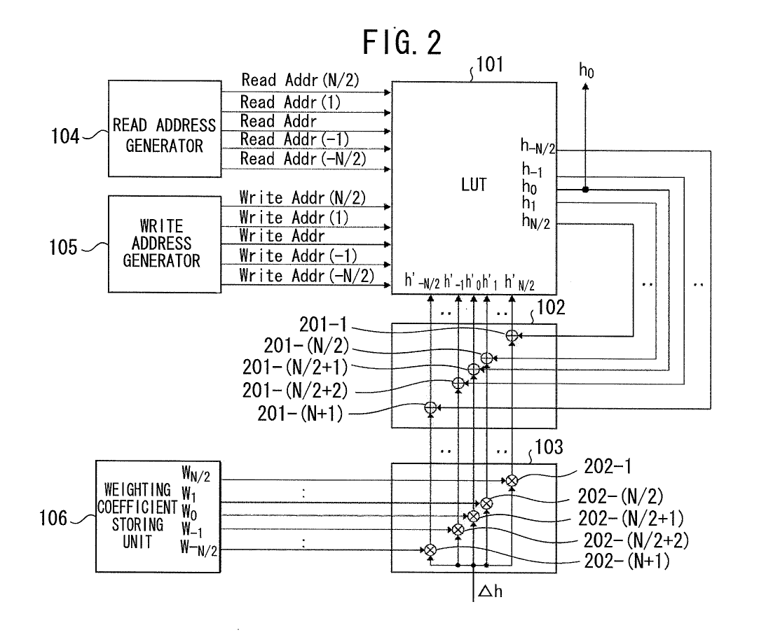

FIG. 2 illustrates an example of the adding unit 102 and the multiplying unit 103 of FIG. 1. The adding unit 102 includes adders 201-1 to 201-(N+1), and the multiplying unit 103 includes multipliers 202-1 to 202-(N+1).

Entries stored at the addresses of N/2 before the address of the distortion compensation coefficient ho are represented by h_{-N/2}, . . . , h₋₁, and entries stored at the addresses of N/2 after the address of the distortion compensation coefficient h0 are represented by h₁, . . . , h_{N/2}. At this time, the distortion compensation coefficients h_{-N/2}, . . . , h₋₁, h₀, h₁, . . . , h_{N/2} are simultaneously updated by executing the updating processing only once.

The read address generator 104 generates the following addresses as the addresses of the distortion compensation coefficients h_{—N/2} to h_{N/2} as updating targets, and LUT 101 outputs the distortion compensation coefficients stored at these addresses. However, the input ReadAddr is directly used as the address of the distortion compensation coefficient ho.

h_{N/2}: ReadAddr (N/2), . . . , h₁: ReadAddr (1), h₀: ReadAddr, h₋₁: ReadAddr (−1) h_{-N/2}: ReadAddr (−N/2) In the weighting coefficient storing unit 106 are stored weighting coefficients w_{-N/2}, . . . , w₋₁, w₀, w₁, . . . , w_{N/2} corresponding to the distortion compensation coefficients h_{-N/2}, . . . , h₋₁, h₀, h₁, . . . , h_{N/2}. The multipliers 202-1 to 202-(N+1) multiply the correction value Δh by the weighting coefficients w_{N/2} to w_{-N/2}, respectively, and the adders 201-1 to 201-(N+1) add the obtained multiplication results of (N+1) to the distortion compensation coefficients h_{N/2} to h_{-N/2}, respectively. Accordingly, the updated values h′_{N/2} to h′_{-N/2} as represented by the following equations are generated.

h′_{N/2}=h_{N/2}+Δh*w_{N/2}, . . . , h′₁=h₁+Δh*w₁, h′₀=h₀+Δh*w₀, h′₋₁=h₋₁+Δh*w₋₁, . . . , h′_{-N/2}=h_{-N/2}+Δh*w_{-N/2}

The write address generator 105 generates the following addresses as the addresses of the updated values h′_{-N/2} to h′_{N/2}, and LUT 101 rewrites the distortion compensation coefficients stored at these addresses to updated values. However, input WriteAddr is directly used as the address of the updated value h′₀.

h′_{N/2}: WriteAddr (N/2), . . . , h′₁: WriteAddr (1), h′₀: WriteAddr, h′₋₁: WriteAddr (−1), h′_{-N/2} WriteAddr (−N/2)

As described above, the same correction value Δh is used for all the distortion compensation coefficients to be updated simultaneously. This correction value Δh is the correction value for the distortion compensation coefficient h₀ as the present processing target. However, the correction value of each of the distortion compensation coefficients hi (i=−N/2, . . . −1, 0, 1, . . . , N/2) is adjusted by multiplying the weighting coefficient wi. When 1 is used as the weighting coefficient w₀, the multiplier 202-(N/2+1) at the center illustrated in FIG. 2 may be omitted.

The plurality of adjacent entries of LUT 101 are simultaneously updated based on the same correction value Δh, whereby the adjacent entries are associated with one another and the correlation of the distortion compensation coefficients multiplied to the input samples is strengthened. Accordingly, the correlation of the signals after the multiplication is strengthened, and thus the band width of the signal S(t)*h after the distortion compensation is reduced. Accordingly, the band width of the signal S(t)*h may be maintained narrower than the DPD band width, and thus the performance deterioration of the distortion compensation processing may be prevented.

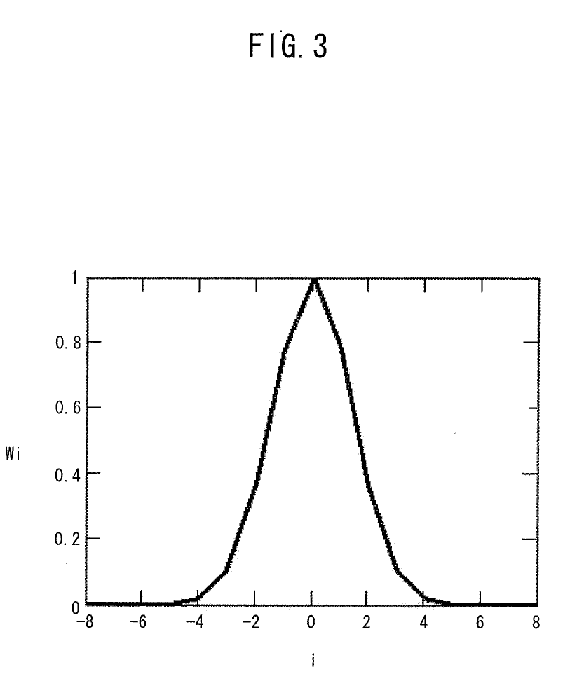

It is desired that the value of the weighting coefficient wi is reduced as the absolute value of the index increases, that is, it is farther away from the distortion compensation coefficient ho at the center. A Gaussian window function may be considered as such a weighting function, for example. FIG. 3 illustrates seventeen weighting coefficients wi (i=−8, 8) calculated by using the Gaussian window function in the case of N=16.

The number N of the distortion compensation coefficients updated simultaneously with the distortion compensation coefficient h0 is not necessarily required to be equal to an even number, but it may be an odd number. Accordingly, N is generally equal to an integer of 1 or more.

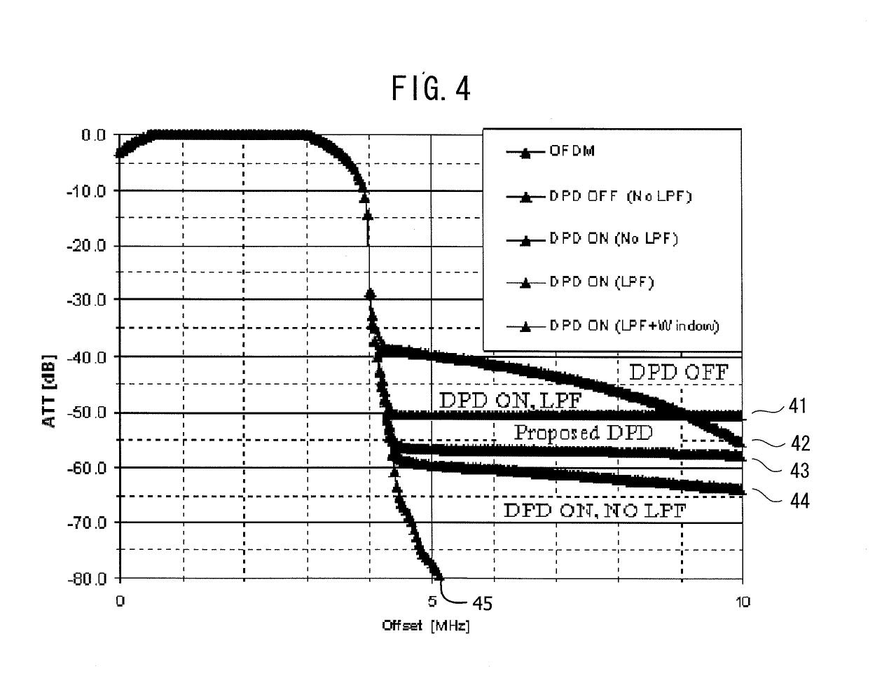

FIG. 4 illustrates an example of the power spectra of the output signals in the conventional distortion compensating amplifier and the distortion compensating amplifier of FIG. 1. In FIG. 4, a spectrum 45 represents a spectrum of an OFDM signal output from an ideal HPA having no non-linear distortion. The OFDM signal has neither amplitude distortion nor phase distortion, and no distortion compensation processing is executed.

The spectrum 42 is the spectrum of an OFDM signal output from a non-linear HPA. This OFDM signal has amplitude-amplitude distortion and amplitude-phase distortion which are non-linear and large, and has a very high out-of-band power level. However, no distortion compensation processing is executed.

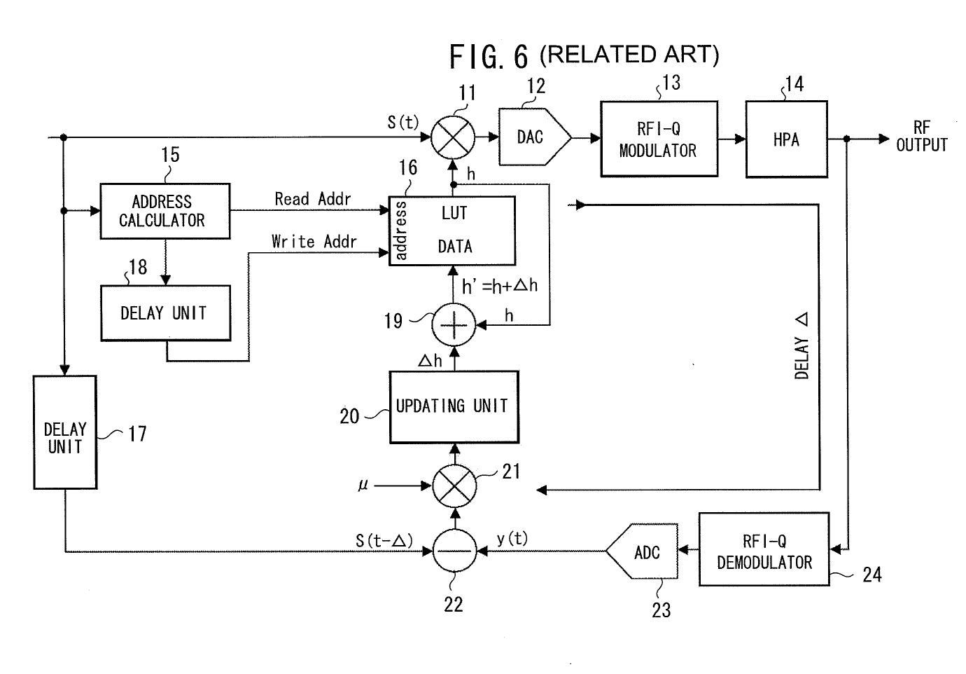

The spectrum 44 is the spectrum of an OFDM signal output from a non-linear HPA in a broad band DPD illustrated in FIG. 6. As compared with the spectrum 42, it is found that the out-of-band power level is lowered by only about 20 dB and the distortion compensation processing acts effectively.

The spectrum 41 is the spectrum of an OFDM signal output from a non-linear HPA in a narrow band DPD illustrated in FIG. 7. As compared with the spectrum 42, it is found that the out-of-band power level is lowered, however, the degree of the reduction of the level is small. As compared with the spectrum 44 of the broad band DPD, the out-of-band power level of the narrow band DPD is higher by only about 10 dB. This fact indicates that the distortion compensation processing suffers band restriction based on LPF.

The spectrum 43 is the spectrum of an OFDM signal from a non-linear HPA in a narrow band DPD illustrated in FIG. 1. As compared with the spectrum 41, it is found that the out-of-band power level is lowered by only about 7 dB, and the performance of the distortion compensation processing is improved.

According to the distortion compensation amplifier as described above, when there is a frequency selecting circuit at the input side or output side of HPA, the RF I-Q modulator or the RF I-Q demodulator, or when the memory effect of HPA exists, the performance of the dynamic tracing loop processing of DPD may be improved.

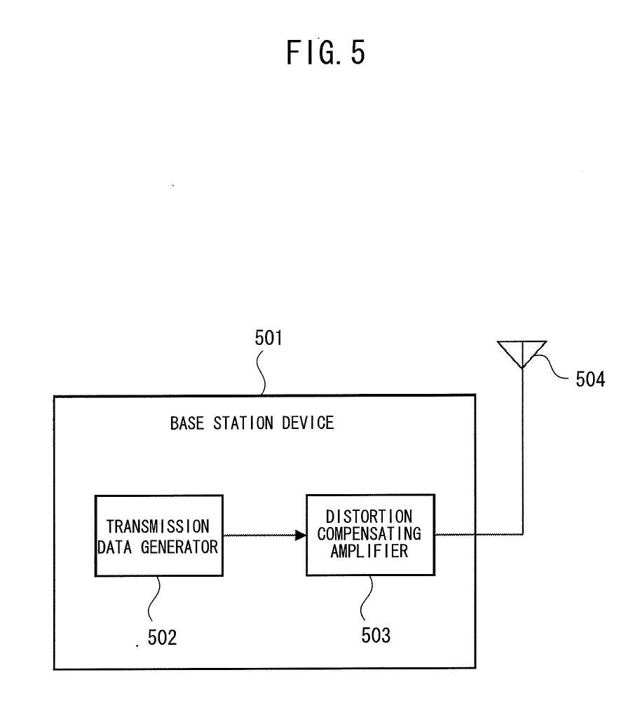

FIG. 5 illustrates an example of the base station device in the OFDM communication system or the like. A base station device 501 includes a transmission data generator 502, a distortion compensation amplifier 503 and an antenna 504. The distortion compensation amplifier 503 has the construction illustrated in FIG. 1, for example, and up-converts the transmission data generated by the transmission data generator 502 as an input signal, and then amplifies the up-converted transmission data. Then, the distortion compensation amplifier 503 transmits the amplified signal through the antenna 504 to a communication device such as a mobile terminal or the like.

According to the distortion compensation coefficient updating apparatus and the distortion compensating amplifier of the above embodiment, the performance deterioration of the distortion compensation processing may be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to illustrating the superiority and inferiority of the invention. Although the embodiment of the present invention has been described in detail, it should be understood that various changes, substitutions, and alterations could be made thereto without departing from the spirit and scope of the invention.

What is claimed is:

1. An apparatus for updating a coefficient for distortion compensation, the apparatus comprising:
a compensation coefficient storing unit configured to store a plurality of distortion compensation coefficients used for a pre-distortion-compensation processing;
a correction value generator configured to generate one or more correction values for one or more distortion compensation coefficients, based on a correction value which is calculated using a transmission signal before distortion compensation processing and an amplified signal after the distortion compensation processing to which a distortion compensation coefficient is applied, other than the applied distortion compensation coefficient; and
an adder configured to add the calculated correction value to the applied distortion compensation coefficient and add the one or more generated correction values to the one or more distortion compensation coefficients to update the plurality of distortion compensation coefficients.

2. The distortion compensation coefficient updating apparatus according to claim 1, wherein the correction value generator comprises:
a weighting coefficient storing unit configured to store one or more weighting coefficients for the one or more distortion coefficient compensation coefficients; and
a multiplying unit configured to multiply the calculated correction value by the one or more weighting coefficients, and outputting the one or more generated correction values obtained by multiplying.

3. The distortion compensation coefficient updating apparatus according to claim 2, wherein the compensation coefficient storing unit stores each distortion compensation coefficient at an address corresponding to amplitude or power of the transmission signal and stores the one or more distortion compensation coefficients at addresses adjacent to the applied distortion compensation coefficient, and values of the weighting coefficients of the one or more distortion compensation coefficients are smaller as addresses of the one or more distortion compensation coefficients are farther from the applied distortion compensation coefficient.

4. The distortion compensation coefficient updating apparatus according to claim 3, wherein the one or more weighting coefficients are calculated by using a Gaussian window function.

5. A distortion compensating amplifier comprising:
a compensation coefficient storing unit configured to store a plurality of distortion compensation coefficients used for a pre-distortion-compensation processing;
an updating unit configured to calculate a correction value based on a transmission signal before distortion compensation processing and an amplified signal after the distortion compensation processing based on a distortion compensation coefficient of the plurality of distortion compensation coefficients;
a correction value generator configured to generate one or more correction values for one or more distortion compensation coefficients other than the distortion compensation coefficient based on the calculated correction value;
an adder configured to add the calculated correction value to the distortion compensation coefficient and add the one or more generated correction values to the one or more other distortion compensation coefficients to update the distortion compensation coefficients stored in the compensation coefficient storing unit;
a multiplying unit configured to multiply a transmission signal before the distortion compensation processing by any of the updated distortion compensation coefficients; and
an amplifying unit configured to amplify a signal obtained by multiplying by the multiplying unit and output the amplified signal.

6. A base station device comprising:
a generator configured to generate a transmission signal before pre-distortion-compensation processing;
a compensation coefficient storing unit configured to store a plurality of distortion compensation coefficients used for distortion compensation processing;
an updating unit configured to calculate a correction value based on the transmission signal and an amplified signal after the distortion compensation processing based on a distortion compensation coefficient of the plurality of distortion compensation coefficients;
a correction value generator configured to generate one or more correction values for one or more distortion compensation coefficients other than the distortion compensation coefficient based on the calculated correction value;
an adder configured to add the calculated correction value to the distortion compensation coefficient and add the one or more generated correction values to the one or more other distortion compensation coefficients to update the distortion compensation coefficients stored in the compensation coefficient storing unit;
a multiplying unit configured to multiply a transmission signal before the distortion compensation processing by any of the updated distortion compensation coefficients; and
an amplifying unit configured to amplify a signal obtained by multiplying by the multiplying unit and output the amplified signal.

7. A method of updating a coefficient for distortion compensation, the method comprising:
generating one or more correction values for one or more distortion compensation coefficients, based on a correction value which is calculated using a transmission signal before distortion compensation processing and an amplified signal after the distortion compensation processing to which a distortion compensation coefficient is applied, other than the applied distortion compensation coefficient; and
updating the applied distortion compensation coefficient based on the calculated correction value and updating the one or more distortion compensation coefficients based on the one or more generated correction values.
